(19) United States
(12) Patent Application Publication
(10) Pub. No.: US 2024/0149336 A1
(43) Pub. Date: May 9, 2024

(54) SINTERING METAL POWDER

(71) Applicant: SEIKO EPSON CORPORATION, TOKYO (JP)

(72) Inventors: Toshiki SANO, Hachinohe-shi (JP); Keisuke AIDA, HACHINOHE-SHI (JP)

(21) Appl. No.: 18/495,371

(22) Filed: Oct. 26, 2023

(30) Foreign Application Priority Data
Oct. 28, 2022 (JP) 2022-173082

(51) Int. Cl. B22F 1/054; B22F 1/065

(52) U.S. Cl. CPC B22F 1/054; B22F 1/065; B22F 2207/13; B33Y 70/00

(57) ABSTRACT

A sintering metal powder, in which a particle size distribution curve has a first peak having a maximum value at a particle diameter D1 [μm] and a second peak having a maximum value at a particle diameter D2 [μm] which is larger than the particle diameter D1, where the particle size distribution curve is drawn by measuring a volume-based particle size distribution of the sintering metal powder with a laser diffraction scattering particle size distribution measurement device, and plotting the particle size distribution on an orthogonal coordinate system in which a horizontal axis is a particle diameter and a vertical axis is a relative particle amount. The particle diameter D2 is 30.0 μm or less, a height of the second peak is 0.60 or more and 3.00 or less when a height of the first peak is 1, and an average degree of circularity calculated from a captured image is 0.70 or more and 1.00 or less.

The present application is based on, and claims priority from JP Application Serial Number 2022-173082, filed Oct. 28, 2022, the disclosure of which is hereby incorporated by reference herein in its entirety.

### BACKGROUND

### 1. Technical Field

The present disclosure relates to a sintering metal powder.

### 2. Related Art

In recent years, additive manufacturing methods using metal powders are widespread as a technique for manufacturing a three-dimensional object. Selective laser sintering (SLS), a binder jet method, fused deposition modeling (FDM), and the like are known as a method of manufacturing a three-dimensional object according to binding principles.

Among these, for example, the binder jet method is a technique of manufacturing a three-dimensional object, including a step of forming a powder layer by flattening a metal powder into a layer using a squeegee or the like, a step of supplying a binder liquid to a part of the powder layer and solidifying the binder liquid, and repeating these steps. Further, by subjecting the obtained three-dimensional object to a sintering treatment, a sintered metal body having a shape of the three-dimensional object can be produced. According to the method, a sintered metal body having a target three-dimensional shape can be efficiently obtained without using a mold or the like.

In order to improve a mechanical strength of the sintered metal body, it is important to improve a filling rate of a metal powder in a powder layer. By improving the filling rate, the mechanical strength of the three-dimensional object to be manufactured can be improved, and the mechanical strength of the sintered metal body can be finally improved.

For example, JP-T-2016-505415 discloses a component additive manufacturing method including a step of forming a powder bed using a powder having a bimodal particle size distribution, and a step of selectively sintering the powder bed by irradiating the powder bed with a laser. The powder having the bimodal particle size distribution is excellent in tightness during filling as compared to a powder having a unimodal particle size distribution. Therefore, by using the powder having the bimodal particle size distribution, it is possible to obtain a powder bed capable of forming a sintered body with a low porosity.

However, fluidity of the powder having the bimodal particle size distribution disclosed in JP-T-2016-505415 is not considered. The fluidity of the powder is a property required when forming a powder bed using a squeegee or the like. When the fluidity of the powder is low, even when the powder itself has a high potential filling property, it is difficult to improve a filling property of the powder bed.

On the other hand, in order to improve the fluidity, a method of increasing a particle diameter of a powder is known. However, when the particle diameter of the powder is increased, a sintering property decreases. Therefore, development of a sintering metal powder that has a high filling property, high fluidity, and a high sintering property becomes an issue.

### SUMMARY

In a sintering metal powder according to an application example of the present disclosure, a particle size distribution curve has a first peak having a maximum value at a particle diameter D1 [μm] and a second peak having a maximum value at a particle diameter D2 [μm] which is larger than the particle diameter D1, where the particle size distribution curve is drawn by measuring a volume-based particle size distribution of the sintering metal powder with a laser diffraction scattering particle size distribution measurement device, and plotting the particle size distribution on an orthogonal coordinate system in which a horizontal axis is a particle diameter and a vertical axis is a relative particle amount. The particle diameter D2 is 30.0 μm or less, a height of the second peak is 0.60 or more and 3.00 or less when a height of the first peak is 1, and an average degree of circularity calculated from a captured image is 0.70 or more and 1.00 or less.

### BRIEF DESCRIPTION OF THE DRAWINGS

FIG. 1 is a diagram showing an example of a particle size distribution curve obtained for a sintering metal powder according to an embodiment.

### DESCRIPTION OF EMBODIMENTS

Hereinafter, a sintering metal powder according to the present disclosure will be described in detail with reference to the accompanying drawing.

### 1. Particle Size Distribution of Sintering Metal Powder

A sintering metal powder according to the embodiment is a powder that is formed together with a binder and then subjected to a sintering treatment. Such a sintering metal powder has a bimodal distribution having two peaks in a particle size distribution curve.

Specifically, a particle size distribution curve PSD is drawn by measuring a volume-based particle size distribution of the sintering metal powder according to the embodiment with a laser diffraction scattering particle size distribution measurement device, and plotting the particle size distribution on an orthogonal coordinate system in which a horizontal axis is a particle diameter and a vertical axis is a relative particle amount. The particle size distribution curve PSD thus created has a first peak P1 having a maximum value at a particle diameter D1 [μm] and a second peak P2 having a maximum value at a particle diameter D2 [μm] which is larger than the particle diameter D1. Examples of the laser diffraction scattering particle size distribution measurement device include Microtrac HRA 9320-X100 manufactured by Nikkiso Co., Ltd.

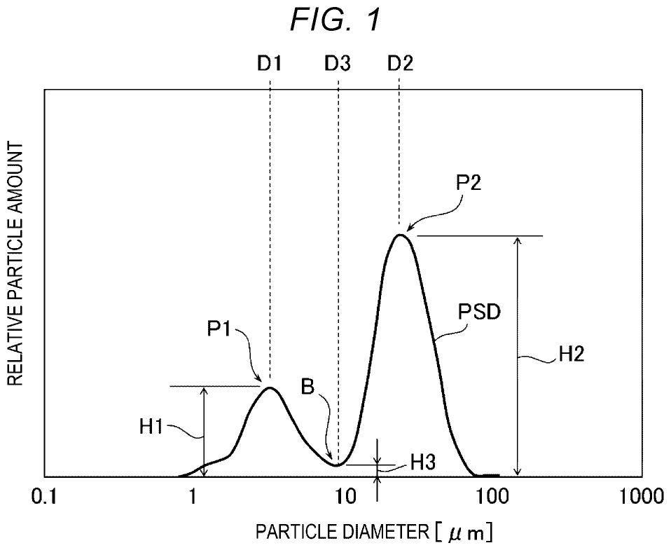

FIG. 1 is a diagram showing an example of the particle size distribution curve PSD obtained for the sintering metal powder according to the embodiment. The horizontal axis in FIG. 1 is a logarithmic axis.

The particle size distribution curve PSD shown in FIG. 1 is a curve having the first peak P1 having a maximum value at the particle diameter D1 [μm] and the second peak P2 having a maximum value at the particle diameter D2 [μm] which is larger than the particle diameter D1.

In the particle size distribution curve PSD, a height H2 of the second peak P2 is 0.60 or more and 3.00 or less when a height H1 of the first peak P1 is 1. The particle diameter D2 is 30.0 μm or less. Further, the sintering metal powder according to the embodiment has an average degree of circularity calculated from a captured image of 0.70 or more and 1.00 or less.

According to such a configuration, since the bimodal distribution is optimized, a quantitative balance between particles belonging to the first peak P1 (small-diameter particles) and particles belonging to the second peak P2 (large-diameter particles) is favorable, and a sintering metal powder having a high filling property and high fluidity can be obtained. Since particles with a high degree of circularity are contained at a high ratio, the filling property and the fluidity can be further improved. Further, when the particle diameter D2 is set within the above range, the particle diameter D1 is smaller, so that a high sintering property is given to the sintering metal powder. As a result, a sintering metal powder having a high filling property, high fluidity, and a high sintering property can be obtained.

The filling property and the fluidity depend on a density and dimensional accuracy of a molded body when a composition containing the sintering metal powder and the binder is molded. The molded body may be, for example, a press molded body, an injection molded body, or an extrusion molded body, or may be an additive manufactured body produced by an additive manufacturing method using a 3D printer. By using the sintering metal powder, the density and the dimensional accuracy of the molded body can be improved. In particular, among the additive manufacturing method, in a method of repeating formation of a powder bed and binding of a powder, for example, in a powder sintering additive manufacturing method and a binder jet method, the filling property of the powder bed is important, and thus the sintering metal powder according to the embodiment is suitable. Further, by using the obtained molded body, it is possible to produce a sintered metal body which is excellent in mechanical strengths such as a strength and rigidity and which is also excellent in dimensional accuracy.

When the height H1 of the first peak P1 is 1, a ratio H2/H1 of the height H2 of the second peak P2 to the height H1 is 0.60 or more and 3.00 or less, preferably 0.70 or more and 2.50 or less, more preferably 0.80 or more and 2.00 or less, and still more preferably 0.80 or more and 1.20 or less. Accordingly, the quantitative balance between the small-diameter particles and the large-diameter particles is particularly favorable, and a sintering metal powder having a higher filling property and fluidity can be obtained. The height H1 refers to a height from an origin to a peak top of the first peak P1 along the vertical axis of the orthogonal coordinate system in which the particle size distribution curve PSD is drawn. The height H2 is a height from the origin to a peak top of the second peak P2 along the vertical axis.

When the ratio H2/H1 of the height H2 to the height H1 is less than the above lower limit value, a volume ratio of the small-diameter particles is too large. Therefore, the quantitative balance between the small-diameter particles and the large-diameter particles is lost, and the filling property and the fluidity decrease. On the other hand, when the ratio H2/H1 of the height H2 to the height H1 exceeds the above upper limit value, a volume ratio of the large-diameter particles is too large. Therefore, the quantitative balance described above is likely to be lost, and the filling property and the fluidity decrease. In addition, since the particle diameter is excessively large as a whole, the sintering property of the sintering metal powder decrease.

The particle diameter D2 is 30.0 μm or less as described above, and is preferably 10.0 μm or more and 25.0 μm or less, and more preferably 20.0 μm or more and 25.0 μm or less. Accordingly, it is possible to obtain a sintering metal powder with which a sintered metal body having small surface roughness and high dimensional accuracy can be produced.

When the particle diameter D2 exceeds the above upper limit value, since the particle diameter is excessively large as a whole, the filling property and the sintering property of the sintering metal powder decrease. In addition, the surface roughness of the produced sintered metal body is large, and the dimensional accuracy is lowered. On the other hand, the particle diameter D2 may be less than the above lower limit value, whereas in this case, there is a concern that a difference from the particle diameter D1 is too small or the particle diameter D1 needs to be further reduced. As a result, the filling property and the fluidity of the sintering metal powder may decrease.

On the other hand, the particle diameter D1 is preferably 0.5 μm or more and 15.0 μm or less, more preferably 1.0 μm or more and 10.0 μm or less, and still more preferably 2.0 μm or more and 5.0 μm or less. Accordingly, it is possible to obtain a sintering metal powder with which a sintered metal body having small surface roughness and high dimensional accuracy can be produced.

The average degree of circularity of the sintering metal powder is 0.70 or more and 1.00 or less as described above, and is preferably 0.75 or more and 1.00 or less, and more preferably 0.77 or more and 1.00 or less. When the average degree of circularity is less than the above lower limit value, a rolling property of particles constituting the sintering metal powder decreases, and thus at least one of the filling property and the fluidity of the sintering metal powder decreases.

The degree of circularity of the particles contained in the sintering metal powder is measured as follows.

First, an image (a secondary electron image) in which a plurality of particles appear is taken by a scanning electron microscope (SEM). Next, the obtained image is read by image processing software. As the image processing software, for example, image analysis type particle size distribution measurement software “Mac-View” manufactured by Mountech Co., Ltd. is used. An imaging magnification is adjusted such that 50 to 100 particles appear in one image. Then, a plurality of images are acquired such that a total of 300 or more particle images is obtained.

Next, the degree of circularity of each particle image is calculated using software to obtain an average value. The obtained average value is an average degree of circularity calculated from the captured image of the particles.

When the particle diameter D1 is 1, the particle diameter D2 is not particularly limited, and is preferably 5.0 or more and 9.0 or less, more preferably 6.0 or more and 8.0 or less, and still more preferably 7.0 or more and 7.7 or less. When a ratio D2/D1 of the particle diameter D2 to the particle diameter D1 is within the above range, a balance between the particle diameter D1 and the particle diameter D2 is favorable. Accordingly, the small-diameter particles enter gaps between the large-diameter particles, and a filling rate is likely to be improved. In addition, contact points between the particles increase, and a sintering phenomenon is likely to occur. As a result, the filling property and the sintering property of the sintering metal powder can be improved.

When the ratio D2/D1 of the particle diameter D2 to the particle diameter D1 is less than the above lower limit value, the ratio is too small, and thus it is difficult for the small-diameter particles to enter the gaps between the large-diameter particles, and the filling rate may decrease. On the other hand, when the ratio D2/D1 of the particle diameter D2 to the particle diameter D1 exceeds the above upper limit value, the gaps is too large, and thus the filling rate may decrease, and the sintering property of the large-diameter particles may decrease.

Further, the particle size distribution curve PSD shown in FIG. 1 has a bottom portion B having a minimum value at a particle diameter D3 between the particle diameter D1 and the particle diameter D2. When the height H1 of the first peak P1 is 1, a height H3 of the bottom portion B is preferably 0.10 or less, and more preferably 0.01 or more and 0.05 or less. The height H3 refers to a height from the origin to a bottom of the bottom portion B along the vertical axis of the orthogonal coordinate system in which the particle size distribution curve PSD is drawn.

In the sintering metal powder exhibiting such a particle size distribution curve PSD, the balance between the particle diameter D1 and the particle diameter D2 is more favorable, and a sintering metal powder having a higher filling property and a higher sintering property can be obtained.

When a ratio H3/H1 of the height H3 to the height H1 exceeds the above upper limit value, the difference between the particle diameter D1 and the particle diameter D2 is small, and thus the filling property of the sintering metal powder decreases, and the contact points between the particles are reduced, which may lead to a decrease in sintering property. On the other hand, the ratio H3/H1 of the height H3 to the height H1 may be less than the above lower limit value, but the difference between the particle diameter D1 and the particle diameter D2 is large, and thus the particle diameter D1 is too small or the particle diameter D2 is too large, which may lead to a decrease in fluidity or sintering property.

When the particle diameter D1 is 1, the particle diameter D3 is not particularly limited, and is preferably 1.5 or more and 5.0 or less, more preferably 2.0 or more and 4.0 or less, and still more preferably 2.5 or more and 3.5 or less. When the ratio D3/D1 of the particle diameter D3 to the particle diameter D1 is within the above range, the balance between the particle diameter D1 and the particle diameter D2 is particularly favorable, and a sintering metal powder having a higher filling property and a higher sintering property can be obtained.

When the ratio D3/D1 of the particle diameter D3 to the particle diameter D1 is less than the above lower limit value, the difference between the particle diameter D1 and the particle diameter D2 is small, and thus the fluidity and the sintering property of the sintering metal powder may decrease. On the other hand, when the ratio D3/D1 of the particle diameter D3 to the particle diameter D1 exceeds the above upper limit value, the difference between the particle diameter D1 and the particle diameter D2 is large, and thus the particle diameter D1 is too small or the particle diameter D2 is too large, which may lead to a decrease in fluidity or sintering property.

The number of peaks of the particle size distribution curve of the sintering metal powder is not limited to two, and may be three or more. That is, when the particle size distribution curve of the sintering metal powder is drawn, the particle size distribution curve may have a multimodal distribution. When the particle size distribution curve has three or more peaks, one of two adjacent peaks may correspond to the first peak P1, and the other may correspond to the second peak P2. In this case, a height of the remaining one or more peaks may be smaller than both the height H1 and the height H2 described above, and is preferably less than half of the lower height, and more preferably ¼ or less of the lower height.

### 2. Constituent Material of Sintering Metal Powder

A constituent material of the sintering metal powder is not particularly limited and may be any metal material. Examples of the constituent material include simple substances such as Fe, Ni, Co, Cu, Ag, Al, Ti, Mo, W, Ta, and Zr, and alloys and intermetallic compounds containing these simple substances as main components.

Among these, examples of Fe-based alloys include stainless steels such as austenitic stainless steels, martensitic stainless steels, and precipitation hardened stainless steels, low carbon steels, carbon steels, heat resistant steels, die steels, high speed tool steels, Fe—Ni-based alloys, and Fe—Ni—Co-based alloys.

Examples of Ni-based alloys include Ni—Cr—Fe-based alloys, Ni—Cr—Mo-based alloys, and Ni—Fe-based alloys.

Examples of Co-based alloys include Co—Cr-based alloys, Co—Cr—Mo-based alloys, and Co—Al—W-based alloys.

Examples of Ti-based alloys include alloys of Ti and metal elements such as Al, V, Nb, Zr, Ta, and Mo, and specifically, Ti-6Al-4V and Ti-6Al-7Nb.

The sintering metal powder may be an aggregate of particles having a single composition, or may be particles having different compositions, that is, aggregates of two or more kinds of particles. In the latter case, it is possible to obtain a sintering metal powder with which a sintered metal body having properties derived from each composition can be produced.

The sintering metal powder may be used in a state of being mixed with a non-metal powder. Examples of the non-metal powder include inorganic powders such as a glass powder and a ceramic powder.

Among these, examples of a constituent material of the ceramic powder include oxide-based ceramics such as silicon oxide, magnesium oxide, calcium oxide, aluminum oxide, titanium oxide, zirconium oxide, boron oxide, and yttrium oxide, and non-oxide-based ceramics such as silicon nitride, aluminum nitride, boron nitride, titanium nitride, silicon carbide, boron carbide, titanium carbide, and tungsten carbide.

The sintering metal powder may be used in a state of being mixed with any additive. Examples of the additive include a rust inhibitor and an antioxidant.

The particles constituting the sintering metal powder may be subjected to a surface treatment. Examples of the surface treatment include a coupling agent treatment. A coupling agent has a functional group and a hydrolyzable group and is used to introduce a functional group to a surface of the particles. Examples of the functional group include a vinyl group, an epoxy group, a styryl group, a methacrylic group, an acrylic group, an amino group, a cyclic structure-containing group, a fluoroalkyl group, a fluoroaryl group, a nitro group, an acyl group, and a cyano group.

### 3. Various Properties of Sintering Metal Powder

An average particle diameter of the sintering metal powder is not particularly limited, and is preferably 3.0 μm or more and 30.0 μm or less, more preferably 4.0 μm or more and 20.0 μm or less, and still more preferably 5.0 μm or more and 15.0 μm or less. Accordingly, a sintering metal powder having a further improved filling property, fluidity, and sintering property can be obtained. In addition, by using such a sintering metal powder, a sintered metal body having small surface roughness and high dimensional accuracy can be obtained.

The average particle diameter of the sintering metal powder refers to a particle diameter D50 where a cumulative frequency is 50% from a small-diameter side in a volume-based cumulative particle size distribution of the sintering metal powder obtained using a laser diffraction particle size distribution measurement device.

When the average particle diameter of the sintering metal powder is less than the above lower limit value, the sintering metal powder is too fine, and thus the filling property may decrease. On the other hand, when the average particle diameter of the sintering metal powder exceeds the above upper limit value, the sintering metal powder is too coarse, and thus the sintering property may decrease.

When a true density of the sintering metal powder is 1, a tap density of the sintering metal powder is not particularly limited, and is preferably 0.65 or more, more preferably 0.67 or more and 0.80 or less, and still more preferably 0.69 or more and 0.77 or less. When a ratio of the tap density to the true density is within the above range, a sintering metal powder having a sufficiently high filling property and fluidity can be obtained.

When the ratio of the tap density to the true density is less than the above lower limit value, the filling property or the fluidity of the sintering metal powder may be insufficient. On the other hand, the ratio of the tap density to the true density may exceed the above upper limit value, but a production variation may increase, and thus the ratio is preferably equal to or less than the above upper limit value.

The tap density (a solid bulk density) of the sintering metal powder is measured by Powder Tester (registered trademark) PT-X, which is a powder property evaluation device manufactured by Hosokawa Micron Corporation, after the sintering metal powder is subjected to a coupling agent treatment. Phenyltrimethoxysilane is used as the coupling agent.

### 4. Method of Producing Sintering Metal Powder

The above-described sintering metal powder is produced by, for example, a method of mixing a first powder and a second powder having an average particle diameter larger than that of the first powder.

The first powder and the second powder may be powders produced by any method. Examples of a production method include various atomization methods such as a water atomization method, a gas atomization method, and a rotary water flow atomization method, a reduction method, a carbonylation method, and a pulverization method.

The first powder and the second powder may be produced by the same method, or may be produced by different methods.

The first powder and the second powder thus produced may be classified if necessary. Accordingly, each particle size distribution of the first powder and the second powder can be adjusted to a target distribution. As a result, the particle size distribution curve of the sintering metal powder can be controlled to a target shape. Examples of a classification method include dry classification such as sieving classification, inertial classification, centrifugal classification, and wind classification, and wet classification such as sedimentation classification.

The first powder and the second powder may be subjected to various pretreatments such as a heat treatment, a plasma treatment, an ozone treatment, and a reduction treatment.

### 5. Application of Sintered Metal Body

The sintering metal powder is molded by various molding methods, and then debindered and sintered to form a sintered metal body. The obtained sintered metal body is used as a material constituting all or a part of, for example, a transportation equipment component such as an automobile component, a bicycle component, a railway vehicle component, a ship component, an aircraft component or a space transporter component, an electronic device component such as a personal computer component, a mobile phone terminal component, a tablet terminal component or a wearable terminal component, a component for electrical equipment such as a refrigerator, a washing machine or an air conditioner, a component for a machine such as a machine tool or a semi-conductor manufacturing apparatus, a component for a plant such as a nuclear power plant, a thermal power plant, a hydroelectric power plant, an oil refinery or a chemical complex, a timepiece component, metalware, a decoration such as a jewelry decoration or an eyeglass frame, or a medical instrument such as a medical scalpel or forceps.

### 6. Effect of Embodiment

As described above, in the sintering metal powder according to the embodiment, the particle size distribution curve PSD has the first peak P1 and the second peak P2, where the particle size distribution curve PSD is drawn by measuring a volume-based particle size distribution of the sintering metal powder with a laser diffraction scattering particle size distribution measurement device, and plotting the particle size distribution on an orthogonal coordinate system in which a horizontal axis is a particle diameter and a vertical axis is a relative particle amount. The first peak P1 has a maximum value at the particle diameter D1 [μm]. The second peak P2 has a maximum value at the particle diameter D2 [μm] which is larger than the particle diameter D1. The particle diameter D2 is 30.0 μm or less. Further, the height H2 of the second peak P2 is 0.60 or more and 3.00 or less when the height H1 of the first peak P1 is 1. Further, an average degree of circularity calculated from a captured image is 0.70 or more and 1.00 or less.

According to such a configuration, since a bimodal distribution of the particle size distribution curve PSD is optimized, a quantitative balance the small-diameter particles and the large-diameter particles is favorable, and a sintering metal powder having a high filling property and a high fluidity can be obtained. Since particles having a high degree of circularity are contained at a high ratio, the filling property and the fluidity can be further improved. Further, since the particle diameter D2 is set within the above range, the particle diameter D1 is smaller, so that a high sintering property is given to the sintering metal powder. As a result, a sintering metal powder having a high filling property, high fluidity, and a high sintering property can be obtained.

In the particle size distribution curve PSD, the height H2 of the second peak P2 is preferably 0.80 or more and 2.00 or less when the height H1 of the first peak P1 is 1. Accordingly, the quantitative balance between the small-diameter particles and the large-diameter particles is particularly favorable, and a sintering metal powder having a higher filling property and fluidity can be obtained.

In the particle size distribution curve PSD, the particle diameter D2 is preferably 5.0 or more and 9.0 or less when the particle diameter D1 is 1. Accordingly, the balance between the particle diameter D1 and the particle diameter D2 is favorable. As a result, the small-diameter particles enter gaps between the large-diameter particles, and a filling rate is likely to be improved. In addition, contact points between the particles increase, and a sintering phenomenon is likely to occur. As a result, the filling property and the sintering property of the sintering metal powder can be improved.

In the particle size distribution curve PSD, the particle diameter D2 is preferably 10.0 μm or more and 25.0 μm or less. Accordingly, it is possible to obtain a sintering metal powder with which a sintered metal body having small surface roughness and high dimensional accuracy can be produced.

The particle size distribution curve PSD has the bottom portion B having a minimum value at the particle diameter D3 between the particle diameter D1 and the particle diameter D2. The height H3 of the bottom portion B is preferably 0.10 or less when the height H1 of the first peak P1 is 1. Accordingly, the balance between the particle diameter D1 and the particle diameter D2 is more favorable, and a sintering metal powder having a higher filling property and a higher sintering property can be obtained.

When a true density of the sintering metal powder is 1, a tap density of the sintering metal powder is preferably 0.65 or more. When a ratio of the tap density to the true density is within the above range, a sintering metal powder having a sufficiently high filling property and fluidity can be obtained.

Although the sintering metal powder according to the present disclosure is described above based on a preferred embodiment, the present disclosure is not limited thereto. For example, the sintering metal powder may have a form of an aggregate formed by aggregating the particles described above, or an aggregate formed by binding the particles.

### EXAMPLES

Next, specific Examples of the present disclosure will be described.

### 7. Production of Sintering Metal Powder

### 7.1. Sample No. 1

A first powder and a second powder having the same constituent material and different average particle diameters were prepared, and mixed to obtain a sintering metal powder. Parameters representing a particle size distribution curve of the obtained sintering metal powder and an average degree of circularity thereof are shown in Table 1. Powders of a precipitation hardened stainless steel 17-4PH (SUS630) produced by a water atomization method were used for the first powder and the second powder.

### 7.2. Sample Nos. 2 to 17

Sintering metal powders were obtained in the same manner as in Sample No. 1 except that the parameters representing the particle size distribution curve of the sintering metal powder and the average degree of circularity were changed as shown in Table 1.

### 7.3. Sample No. 18

Only the first powder having the particle diameter D1 shown in Table 1 was used as a sintering metal powder of Sample No. 18.

### 7.4. Sample No. 19

Only the second powder having the particle diameter D2 shown in Table 1 was used as a sintering metal powder of Sample No. 19.

TABLE 1

| | | | | | | | | | Average |
|---|---|---|---|---|---|---|---|---|---|
| | | | | | | | | | degree of |
| | | Parameter representing particle size distribution curve of sintering metal | | | | | | | circularity of |
| | | powder | | | | | | | sintering |
| | | Peak | | | | Bottom portion | | | metal |
| | | D1 | D2 | D2/D1 | H2/H1 | D3 | D3/D1 | H3/H1 | powder |
| | | μm | μm | — | — | μm | — | — | — |
| Sample | Comparative | 3.2 | 23.0 | 7.2 | 0.50 | 9.0 | 2.8 | 0.01 | 0.80 |
| No. 1 | Example | | | | | | | | |
| Sample | Example | 3.2 | 23.0 | 7.2 | 0.65 | 9.0 | 2.8 | 0.02 | 0.81 |
| No. 2 | | | | | | | | | |
| Sample | Example | 3.2 | 23.0 | 7.2 | 0.73 | 9.0 | 2.8 | 0.02 | 0.82 |
| No. 3 | | | | | | | | | |
| Sample | Example | 3.2 | 23.0 | 7.2 | 0.80 | 9.0 | 2.8 | 0.03 | 0.83 |
| No. 4 | | | | | | | | | |
| Sample | Example | 3.2 | 23.0 | 7.2 | 0.85 | 9.0 | 2.8 | 0.03 | 0.85 |
| No. 5 | | | | | | | | | |
| Sample | Example | 3.2 | 23.0 | 7.2 | 0.90 | 9.0 | 2.8 | 0.03 | 0.85 |
| No. 6 | | | | | | | | | |
| Sample | Example | 3.2 | 23.0 | 7.2 | 1.00 | 8.9 | 2.8 | 0.03 | 0.83 |
| No. 7 | | | | | | | | | |
| Sample | Example | 3.2 | 23.0 | 7.2 | 1.20 | 8.9 | 2.8 | 0.03 | 0.82 |
| No. 8 | | | | | | | | | |
| Sample | Example | 3.2 | 23.0 | 7.2 | 1.60 | 8.8 | 2.8 | 0.03 | 0.80 |
| No. 9 | | | | | | | | | |
| Sample | Example | 3.2 | 23.0 | 7.2 | 1.85 | 8.8 | 2.8 | 0.03 | 0.79 |
| No. 10 | | | | | | | | | |
| Sample | Example | 3.2 | 23.0 | 7.2 | 2.00 | 8.7 | 2.7 | 0.03 | 0.78 |
| No. 11 | | | | | | | | | |
| Sample | Example | 3.2 | 23.0 | 7.2 | 2.30 | 8.6 | 2.7 | 0.03 | 0.77 |
| No. 12 | | | | | | | | | |
| Sample | Example | 3.2 | 23.0 | 7.2 | 2.60 | 8.5 | 2.7 | 0.03 | 0.75 |
| No. 13 | | | | | | | | | |
| Sample | Example | 3.2 | 23.0 | 7.2 | 2.80 | 8.4 | 2.6 | 0.03 | 0.73 |
| No. 14 | | | | | | | | | |
| Sample | Comparative | 3.2 | 23.0 | 7.2 | 3.10 | 8.3 | 2.6 | 0.04 | 0.73 |
| No. 15 | Example | | | | | | | | |
| Sample | Comparative | 3.2 | 23.0 | 7.2 | 3.20 | 8.2 | 2.6 | 0.04 | 0.72 |
| No. 16 | Example | | | | | | | | |
| Sample | Comparative | 3.2 | 23.0 | 7.2 | 4.13 | 8.0 | 2.5 | 0.05 | 0.71 |
| No. 17 | Example | | | | | | | | |
| Sample | Comparative | 3.2 | — | — | — | — | — | — | 0.82 |
| No. 18 | Example | | | | | | | | |
| Sample | Comparative | — | 23.0 | — | — | — | — | — | 0.83 |
| No. 19 | Example | | | | | | | | |

### 7.5. Sample Nos. 20 to 29

Sintering metal powders were obtained in the same manner as in Sample No. 1 except that the parameters representing the particle size distribution curve of the sintering metal powder and the average degree of circularity were changed as shown in Table 2.

TABLE 2

| | | | | | | | | | Average |
|---|---|---|---|---|---|---|---|---|---|
| | | | | | | | | | degree of |
| | | Parameter representing particle size distribution curve of | | | | | | | circularity |
| | | sintering metal powder | | | | | | | of sintering |
| | | Peak | | | | Bottom portion | | | metal |
| | | D1 | D2 | D2/D1 | H2/H1 | D3 | D3/D1 | H3/H1 | powder |
| | | μm | μm | — | — | μm | — | — | — |
| Sample | Example | 3.2 | 19.0 | 5.9 | 0.80 | 8.3 | 2.6 | 0.06 | 0.81 |
| No. 20 | | | | | | | | | |
| Sample | Example | 3.2 | 21.0 | 6.6 | 0.90 | 8.6 | 2.7 | 0.04 | 0.82 |
| No. 21 | | | | | | | | | |
| Sample | Example | 3.2 | 25.0 | 7.8 | 1.20 | 9.2 | 2.9 | 0.02 | 0.83 |
| No. 22 | | | | | | | | | |
| Sample | Example | 3.2 | 27.0 | 8.4 | 0.90 | 9.4 | 2.9 | 0.01 | 0.85 |
| No. 23 | | | | | | | | | |
| Sample | Example | 2.8 | 23.0 | 8.2 | 1.10 | 9.0 | 3.2 | 0.04 | 0.85 |
| No. 24 | | | | | | | | | |
| Sample | Example | 4.0 | 23.0 | 5.8 | 1.00 | 8.9 | 2.2 | 0.05 | 0.83 |
| No. 25 | | | | | | | | | |
| Sample | Example | 2.6 | 23.0 | 8.8 | 1.20 | 8.9 | 3.4 | 0.03 | 0.82 |
| No. 26 | | | | | | | | | |
| Sample | Example | 4.6 | 23.0 | 5.0 | 1.60 | 9.5 | 2.1 | 0.07 | 0.80 |
| No. 27 | | | | | | | | | |
| Sample | Comparative | 3.2 | 35.0 | 10.9 | 1.00 | 8.3 | 2.6 | 0.04 | 0.85 |
| No. 28 | Example | | | | | | | | |
| Sample | Comparative | 3.2 | 23.0 | 7.2 | 1.10 | 9.0 | 2.8 | 0.03 | 0.67 |
| No. 29 | Example | | | | | | | | |

In Tables 1 and 2, among the sintering metal powders of the respective sample Nos., those corresponding to the present disclosure are shown as “Examples”, and those not corresponding to the present disclosure are shown as “Comparative Examples”.

### 8. Evaluation of Sintering Metal Powder

Tap densities of the sintering metal powders of Examples and Comparative Examples were measured. Then, a ratio of the tap density to the true density (7.78 g/cm³) of the constituent material was calculated. Measurement results and calculation results are shown in Tables 3 and 4.

### 9. Evaluation of Sintered Metal Body

Using the sintering metal powder of each of Examples and Comparative Examples, an additive manufactured body having a rectangular parallelepiped shape was prepared by a binder jet method. A size of the prepared additive manufactured body was 40 mm in length, 20 mm in width, and 5 mm in thickness. A stearic acid emulsion was used as a binder solution.

Subsequently, the prepared additive manufactured body (a molded body) was subjected to a debindering treatment to be debindered, and then sintered in a firing furnace. A sintering condition was set to 1100° C.×3 hours in an argon atmosphere. Accordingly, a sintered metal body was obtained.

### 9.1. Relative Density

A density of the obtained sintered metal body was measured. Next, a relative value of the measured density to a true density of the used sintering metal powder, that is, a relative density was calculated. Then, the calculated relative density was evaluated in light of the following evaluation criteria. Evaluation results are shown in Tables 3 and 4.
A: the relative density is 99.5% or more.
B: the relative density is 99.0% or more and less than 99.5%.
C: the relative density is 98.5% or more and less than 99.0%.
D: the relative density is 98.0% or more and less than 98.5%.
E: the relative density is 97.5% or more and less than 98.0%.
F: the relative density is less than 97.5%.

### 9.2. Tensile Load

A load test of pulling the obtained sintered metal body in a length direction was performed. Next, a maximum load until fracture was measured as a tensile load. Next, a relative value of the measured tensile load with respect to a tensile load (a reference value) of the sintered metal body produced using the sintering metal powder of Sample No. 19 was calculated. Then, the calculated relative value was evaluated in light of the following evaluation criteria. Evaluation results are shown in Tables 3 and 4.

A: the relative value of the tensile load is 120% or more of the reference value.

B: the relative value of the tensile load is 115% or more and less than 120% of the reference value.

C: the relative value of the tensile load is 110% or more and less than 115% of the reference value.

D: the relative value of the tensile load is 105% or more and less than 110% of the reference value.

E: the relative value of the tensile load is more than 100% and less than 105% of the reference value.

F: the relative value of the tensile load is 100% or less of the reference value.

### 9.3. Surface Roughness

Surface roughness of the obtained sintered metal body was measured. The surface roughness refers to arithmetic mean roughness Ra, and was measured according to a method specified in JIS B 0671-1:2002. Next, a relative value of the measured surface roughness with respect to surface roughness (a reference value) of the sintered metal body produced using the sintering metal powder of Sample No. 19 was calculated. Then, the calculated relative value was evaluated in light of the following evaluation criteria. Evaluation results are shown in Tables 3 and 4.
A: the relative value of the surface roughness is less than 80% of the reference value.
B: the relative value of the surface roughness is 80% or more and less than 85% of the reference value.
C: the relative value of the surface roughness is 85% or more and less than 90% of the reference value.
D: the relative value of the surface roughness is 90% or more and less than 95% of the reference value.
E: the relative value of the surface roughness is 95% or more and less than 100% of the reference value.
F: the relative value of the surface roughness is 100% or more of the reference value.

TABLE 3

| | | Evaluation result of sintering | | | | |
|---|---|---|---|---|---|---|
| | | metal powder | | Evaluation result of | | |
| | | | Ratio of tap | sintered metal body | | |
| | | | density to true | Relative | Tensile | Surface |
| | | Tap density | density | density | load | roughness |
| | | g/cm³ | — | — | — | — |
| Sample No. 1 | Comparative | 4.93 | 0.63 | D | D | B |
| | Example | | | | | |
| Sample No. 2 | Example | 5.06 | 0.65 | B | B | B |
| Sample No. 3 | Example | 5.19 | 0.67 | B | B | B |
| Sample No. 4 | Example | 5.32 | 0.68 | B | B | A |
| Sample No. 5 | Example | 5.45 | 0.70 | A | A | A |
| Sample No. 6 | Example | 5.58 | 0.72 | A | A | A |
| Sample No. 7 | Example | 5.60 | 0.72 | A | A | A |
| Sample No. 8 | Example | 5.51 | 0.71 | A | A | A |
| Sample No. 9 | Example | 5.42 | 0.70 | A | A | A |
| Sample No. 10 | Example | 5.33 | 0.69 | B | B | A |
| Sample No. 11 | Example | 5.24 | 0.67 | B | B | B |
| Sample No. 12 | Example | 5.14 | 0.66 | C | C | B |
| Sample No. 13 | Example | 5.09 | 0.65 | C | C | C |
| Sample No. 14 | Example | 5.06 | 0.65 | C | C | C |
| Sample No. 15 | Comparative | 5.00 | 0.64 | D | D | D |
| | Example | | | | | |
| Sample No. 16 | Comparative | 5.00 | 0.64 | D | D | D |
| | Example | | | | | |
| Sample No. 17 | Comparative | 4.95 | 0.64 | D | D | E |
| | Example | | | | | |
| Sample No. 18 | Comparative | 4.80 | 0.62 | F | F | C |
| | Example | | | | | |
| Sample No. 19 | Comparative | 4.70 | 0.60 | F | — | — |
| | Example | | | | | |

TABLE 4

| | | Evaluation result of | | | | |
|---|---|---|---|---|---|---|
| | | sintering metal powder | | | | |
| | | | Ratio of tap | Evaluation result of sintered metal body | | |
| | | Tap | density to | Relative | Tensile | Surface |
| | | density | true density | density | load | roughness |
| | | g/cm³ | — | — | — | — |
| Sample No. | Example | 5.06 | 0.65 | B | B | A |
| 20 | | | | | | |
| Sample No. | Example | 5.19 | 0.67 | B | B | A |
| 21 | | | | | | |
| Sample No. | Example | 5.32 | 0.68 | B | B | A |
| 22 | | | | | | |
| Sample No. | Example | 5.45 | 0.70 | B | B | B |
| 23 | | | | | | |
| Sample No. | Example | 5.58 | 0.72 | B | B | B |
| 24 | | | | | | |
| Sample No. | Example | 5.60 | 0.72 | B | B | B |
| 25 | | | | | | |
| Sample No. | Example | 5.51 | 0.71 | C | C | B |
| 26 | | | | | | |
| Sample No. | Example | 5.42 | 0.70 | C | C | C |
| 27 | | | | | | |
| Sample No. | Comparative | 5.00 | 0.64 | E | E | F |
| 28 | Example | | | | | |
| Sample No. | Comparative | 5.00 | 0.64 | D | D | C |
| 29 | Example | | | | | |

As is clear from Tables 3 and 4, the ratio of the tap density to the true density of the sintering metal powder of each Example is favorable. Therefore, it is confirmed that the sintering metal powder of each Example is excellent in filling property and fluidity.

In addition, the sintered metal body produced using the sintering metal powder of each Example has a favorable relative density and tensile load. That is, it is clear that, by using the sintering metal powder of each Example, a molded body having a high filling rate can be produced, a sintered metal body having a high density can be produced by sintering the molded body, and the sintered metal body has a high mechanical strength. Therefore, it is confirmed that the sintering metal powder of each Example is excellent in filling property, fluidity, and sintering property.

Further, the sintered metal body produced using the sintering metal powder of each Example has favorable surface roughness, that is, a relatively smooth surface. This also supports that the sintering metal powder of each Example is excellent in filling property.

What is claimed is:

1. A sintering metal powder, wherein
a particle size distribution curve has a first peak having a maximum value at a particle diameter D1 [μm] and a second peak having a maximum value at a particle diameter D2 [μm] which is larger than the particle diameter D1, where the particle size distribution curve is drawn by measuring a volume-based particle size distribution of the sintering metal powder with a laser diffraction scattering particle size distribution measurement device, and plotting the particle size distribution on an orthogonal coordinate system in which a horizontal axis is a particle diameter and a vertical axis is a relative particle amount,
the particle diameter D2 is 30.0 μm or less,
a height of the second peak is 0.60 or more and 3.00 or less when a height of the first peak is 1, and
an average degree of circularity calculated from a captured image is 0.70 or more and 1.00 or less.

2. The sintering metal powder according to claim 1, wherein
the height of the second peak is 0.80 or more and 2.00 or less when the height of the first peak is 1.

3. The sintering metal powder according to claim 1, wherein
the particle diameter D2 is 5.0 or more and 9.0 or less when the particle diameter D1 is 1.

4. The sintering metal powder according to claim 1, wherein
the particle diameter D2 is 10.0 μm or more and 25.0 μm or less.

5. The sintering metal powder according to claim 1, wherein
the particle size distribution curve has a bottom portion having a minimum value at a particle diameter D3 between the particle diameter D1 and the particle diameter D2, and
a height of the bottom portion is 0.10 or less when the height of the first peak portion is 1.

6. The sintering metal powder according to claim 1, wherein
a tap density is 0.65 or more when a true density is 1.
